(19) United States
(12) Patent Application Publication
(10) Pub. No.: US 2007/0015516 A1
(43) Pub. Date: Jan. 18, 2007

(54) Access point with location application systems and methods

(76) Inventors: Allen J. Huotari, Garden Grove, CA (US); Matthew B. McRae, Laguna Beach, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/180,113

(22) Filed: Jul. 12, 2005

(51) Int. Cl. H04Q 7/20

(52) U.S. Cl. 455/456.1

(57) ABSTRACT

Systems and methods are disclosed herein to provide location determination capability and applications for an access point. For example, in accordance with an embodiment of the present invention, a network access point includes a processor adapted to control at least one function of the access point device and a memory coupled to the processor. A first interface transfers information between the access point device and a client device, while a second interface transfers information between the access point device and the network. The access point device further includes a receiver that processes global positioning system signals to determine an approximate location of the access point device.

### TECHNICAL FIELD

The present invention relates generally to wireless and network applications and, more particularly, to location determination and applications.

### BACKGROUND

Access points, such as for example wireless access points (commonly referred to as hot spots), are rapidly being deployed to provide Internet access for public or customer use. For example, wireless access points are being located in a variety of locations, such as within private businesses and residences, public parks, restaurants, airports, and other locations generally frequented by a large number of people.

One drawback of a typical access point, such as for the Internet, is that it is difficult to determine where a user of the access point is located as the access point could be located anywhere in the world. This makes it difficult to provide various services to the user of the access point. For example, emergency calls (e.g., a 911 call) via the access point using an IP telephone (e.g., a dual-mode phone) would not provide emergency personnel with information as to the caller's location as would normally be provided if the caller was using a conventional telephone line.

A conventional approach, for example, may be to incorporate a global positioning system receiver within the IP telephone (or other type of client device able to utilize the network access point). However, there are many disadvantages to this approach, including additional power requirements, shorter battery life, increased manufacturing costs, and/or an increase in the size of the portable IP telephone. As a result, there is a need for improved location determination techniques.

### BRIEF DESCRIPTION OF THE DRAWINGS

FIG. 1 shows a block diagram illustrating a communication system having an access point and an associated network in accordance with an embodiment of the present invention.

FIG. 2 shows a block diagram illustrating an exemplary implementation of the access point of FIG. 1 in accordance with an embodiment of the present invention.

FIG. 3 shows an exemplary functional block diagram implementation of the access point of FIG. 1 in accordance with an embodiment of the present invention.

FIG. 4 shows a diagram illustrating location applications in accordance with an embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

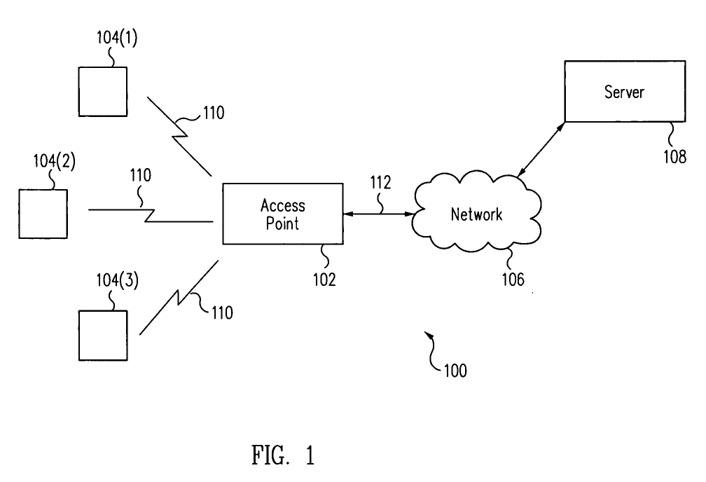

FIG. 1 shows a block diagram illustrating a communication system 100 in accordance with an embodiment of the present invention. Communication system 100 includes an access point 102, one or more clients 104, and a network 106.

Access point 102 may represent a router, a gateway, or any other type of access device for providing communication between one or more clients 104 (e.g., clients 104(1) through 104(3)) and network 106. A server 108 may be connected to network 106 to communicate with and provide information via network 106 and access point 102 to client 104.

Each client 104 (e.g., client 104(1)) may represent a personal digital assistant (PDA), a laptop, and/or an Internet protocol (IP) telephone (e.g., a dual-mode phone or a Wi-Fi phone) or any other type of device that can transmit and/or receive information through network 106 via access point 102. Network 106 may represent the Internet or other type of network, such as a wide area network, with one or more servers 108 providing network content or other information.

Information is provided between clients 104 and access point 102 via corresponding interfaces 110. Each interface 110 may represent, for example, a wired interface (e.g., a network line such as an Ethernet line) or a wireless interface (e.g., IEEE 802.11 interface such as 11a, 11b, 11g, or 11n or other type of wireless communication system or protocol, including Wi-Fi, Bluetooth, or ultrawideband (UWB)). For example, access point 102 may provide wireless local area network (WLAN) access to clients 104. Similarly, an interface 112 may be a wired interface (e.g., a cable or a digital subscriber line (DSL)) or a wireless interface (e.g., a Wi-Fi, a cellular, or a satellite communication system) that provides access to network 106 (e.g., via an Internet service provider or other network service provider). In general, for example, if access point 102 is implemented to provide Internet access (e.g., via a WAN port) to one or more clients 104, various conventional technologies may be implemented (e.g., Ethernet, xDSL, DOCSIS, Frame, or WiMax).

As an exemplary implementation in accordance with an embodiment of the present invention, network 106 may represent the Internet with a plurality of connected servers 108, interface 112 may represent a DSL connection of an Internet service provider (ISP) for access point 102, interface 110 may represent a wireless interface, and access point 102 provides a wireless access point (hot spot) for a public location (e.g., an airport). For this example, access point 102 may route a voice conversation between client 104(1) and network 106 (e.g., provide voice over Internet Protocol (IP) or VoIP communications) or transfer data or other information between client 104(1) and network 106.

Access point 102, in accordance with one or more embodiments of the present invention, includes a global positioning system (GPS) receiver to provide location information. By having access point 102 provide location information, certain advantages may be obtained. For example, this approach may be more cost effective to have location information provided for clients 104 than having each client 104 determine its own location (e.g., each client 104 having a GPS receiver). Consequently, the design of clients 104 is not adversely affected, as may be the case if clients 104 had to determine their own location independently (e.g., resulting in a larger form factor, larger battery or shorter battery life, and/or increased manufacturing costs).

Although the location information provided to clients 104 by access point 102 may be less accurate than if clients 104 received the GPS signals and determined their own location, the accuracy is still sufficient for the techniques and applications discussed herein. For example, client 104(1) may be several hundred feet from access point 102 while communicating wirelessly through access point 102, but this would still be accurate enough for localized information or content (as discussed further herein) and may provide sufficient position information for emergency services (e.g., 911 services).

It should be understood that access point 102 is not limited to GPS technology and that other forms of location determination technology may alternatively be implemented as would be understood by one skilled in the art. For example, GLONASS (global navigation satellite system), cellular, or similar techniques may be employed to determine location by access point 102.

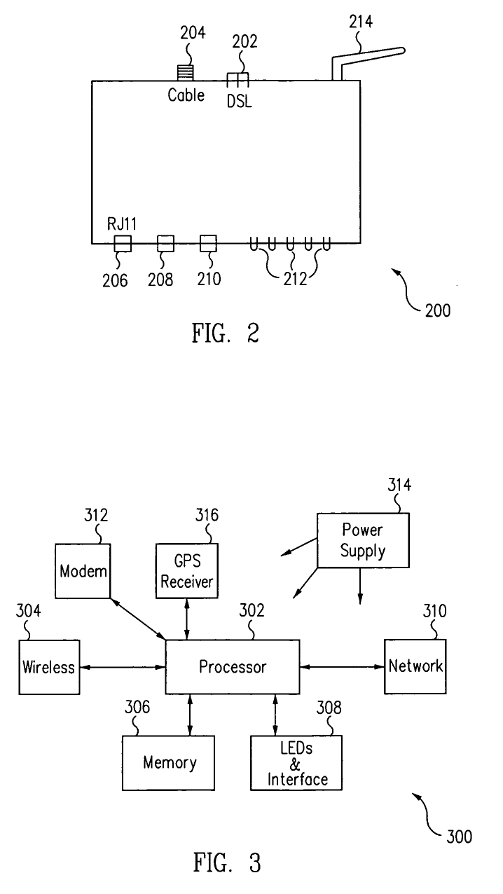

FIG. 2 shows a block diagram of an access point 200, which represents an exemplary implementation of access point 100 (FIG. 1) in accordance with an embodiment of the present invention. Access point 200 may include a DSL terminal 202, a cable terminal 204, a conventional telephone jack 206, one or more network jacks 208, one or more terminals 210, one or more indicator lights 212, and/or one or more antennas 214, depending upon the desired application or requirements.

DSL terminal 202 provides a connection point for a DSL network gateway. For example, DSL terminal 202 may be the connection point for a DSL modem that provides a gateway to a network (e.g., a network 106 of FIG. 1) or the DSL modem may be incorporated into access point 200 and DSL terminal 202 provides a connection point for a telephone line providing DSL service and access to the network.

Similarly, cable terminal 204 provides a connection point for a cable gateway to the network. Cable terminal 204 may be a connection point for a cable modem or the cable modem may be incorporated into access point 200, with cable terminal 204 providing a connection point for a cable line that provides access to the network (e.g., a network 106 of FIG. 1).

Access point 200 may include one or more conventional telephone jacks 206 (e.g., RJ11) to connect, for example, to a conventional telephone or other device (e.g., a facsimile machine or an answering machine). Access point 200 may also include one or more network jacks 208 (e.g., RJ45) to connect, for example, to other network-capable devices (e.g., computers, network telephones, a copy machine, or a printer). Access point 200 may also include one or more terminals 210 (e.g., a universal serial bus (USB) or other type of terminal), which may serve as a connection point for devices within communication system 100.

Access point 200 may provide status and other information via one or more lights 212 (e.g., light emitting diodes (LEDs)), such as a power indication, network activity (e.g., wired and/or wireless), and telephone or other device activity. One or more antennas 214 may also be incorporated into access point 200 to receive GPS signals and to provide wireless connectivity to one or more clients 104 (e.g., network telephones, computers, and/or other wired devices via interface 110) or to network 112 (via interface 112).

For example, one antenna 214 may be utilized to receive GPS signals, which can be processed by access point 200 (or one of clients 104) to determine an approximate location of access point 200, as would be understood by one skilled in the art. If access point 200 is in a location, for example, where the GPS signals can not be received or are weak, antenna 214 for receiving GPS signals may be located remotely or some distance away from access point 200. For example, antenna 214 for GPS may be located near a window or on a roof having a strong GPS satellite signal level and connected to access point 200 (e.g., an antenna port of access point 200) via an antenna cable or other suitable antenna connector.

FIG. 3 shows a functional block diagram of an access point 300, which represents an exemplary implementation of access point 200 of FIG. 2 in accordance with an embodiment of the present invention. Access point 300 includes a processor 302, a wireless interface 304, a memory 306, an interface block 308, a network interface 310, a modem 312, a power supply 314, and a GPS receiver 316.

Processor 302 monitors various aspects or operations of access point 300 and controls or executes various functions of access point 300. Processor 302 may also incorporate and implement one or more functional block diagram aspects of access point 300. For example, processor 302 may incorporate and implement modem 312, wireless interface 304, GPS receiver 316, and/or network interface 310. Processor 302 may also provide various other functions, such as for example to provide print server functionality for a printer connected to access point 300.

Wireless interface 304 controls the wireless interface between access point 300 and one or more clients 104. As an example, wireless interface 304 may operate to provide Wi-Fi connectivity (e.g., IEEE 802.11g standard) to clients 104. Memory 306 may represent static random access memory, flash memory, electrically erasable programmable read only memory, and/or other types of memory for access point 300.

Interface block 308 provides status lights, a power switch, and/or a reset switch to assist a user to maintain proper operation of access point 300 and provide relevant information and appropriate connections to external devices. Network interface 310 controls the interface (e.g., wired or wireless) between access point 300 and a network (e.g., network 106). Modem 312 provides modulation and demodulation for network interface 310, such as to provide DSL modem or cable modem functionality. Modem 312 may be incorporated into network interface 310 or processor 302 or may be provided as a separate device from access point 300.

Power supply 314 (e.g., a battery or a backup battery and/or an alternating current (AC) adapter) supplies the appropriate power levels to electrical components (e.g., processor 302 and memory 306) of access point 300. GPS receiver 316 represents the circuitry and/or software for receiving the GPS signals and processing to determine an approximate location of access point 300.

As an exemplary implementation (referring to FIGS. 1, 2, and 3), access point 300 may represent a wireless-G voice cable gateway (or wireless-G router) which may support multiple voice communications or channels. Thus, for example, wireless interface 304 may support the IEEE 802.11g standard, modem 312 may provide a cable modem that supports data over cable service interface specifications (DOCSIS 1.0, 1.1, and/or 2.0), and interface block 308 may support multiple Ethernet ports, a cable terminal, two or more antennas (e.g., one antenna for GPS and one or more antennas for 802.11g), and indicator lights.

Processor 302, for example, which may include network interface 310 and modem 312, may support media gateway control protocols (MGCP) or PacketCable 1.1 specifications. Processor 302 may also provide other support functions to interface with clients 104. For example, processor 302 may provide CODEC functions (e.g., G.729, G.723, and/or G.711), transmission control protocol/IP (TCP/IP) or dynamic host configuration protocol (DHCP) support, network address translation (NAT), dual-tone-multi-frequency (DTMF) tone detection and generation, facsimile pass-through capability (e.g., G.711 pass-through and/or G.711 facsimile mode), dynamic jitter buffer, line echo cancellation, and/or automated or manual configuration and control.

Similarly, clients 104 may support various functions to interface with access point 300. For example, one or more clients 104 may support VoIP protocols, such as for example session initiation protocol (SIP), MGCP, and/or H.323, provide CODEC functions (e.g., G.729, G.723, and/or G.711), and/or support TCP/IP and DHCP client functions. One or more clients 104 may also provide wireless transmission/reception, Wi-Fi protected access (WPA) wireless security support (e.g., Wi-Fi IP telephone), DTMF tone detection and generation, dynamic jitter buffer, line echo cancellation, automated or manual configuration and control, and/or support quality of service (QoS) protocols to ensure voice quality.

By integrating location determination features into access point 102 (or access point 200 or 300), such as by utilizing GPS technology, unique functionality may be provided via access point 102. For example, access point 102 may determine its location without user intervention or may provide GPS information (e.g., pseudoranges) to clients 104 so that clients 104 can determine the approximate location or to server 108 so that server 108 can determine the approximate location of access point 100 and, consequently, clients 104. In general, the location information determined by GPS includes latitude and longitude and optionally altitude.

Furthermore, if access point 102 is moved to a new location, access point 102 may determine its new location automatically, without requiring an operator to provide manually the location information to access point 102. Automatically determining the new location by access point 102 may provide certain advantages over manually entering or reprogramming the information into access point 102. For example, the current location will be reliable and correct, even if access point 102 is moved, and may be relied upon for emergency services (e.g., 911 calls) or for providing localized content or other information.

The location information received by access point 102 may be utilized to provide additional functionality in accordance with one or more embodiments of the present invention. As an example, various types of entities (e.g., wireless clients, service providers, companies, and/or content providers) may utilize the location information of access point 102 to provide consumer/user location based information or services to clients 104.

For example, if a user (i.e., a user of one of clients 104 of FIG. 1) connects to the Internet via access point 102 (e.g., a wireless hot spot located in Los Angeles, Calif.), an entity such as a service provider for client 104 or access point 102 may provide the user with localized information. The localized information (or localized content) may include, for example, local restaurants, local restaurant reviews, local movie theatres (e.g., locations with list of movies and their starting times), local vehicle repair shops, local stores, local tourist attractions or list of local things to see and do, local city guide, local weather forecast, local maps and directions, local white or yellow pages, local advertisements, and other relevant information based on the user's actual location. Thus, information provided to or from client 104 via access point 102 may be tailored based on the location information determined by access point 102.

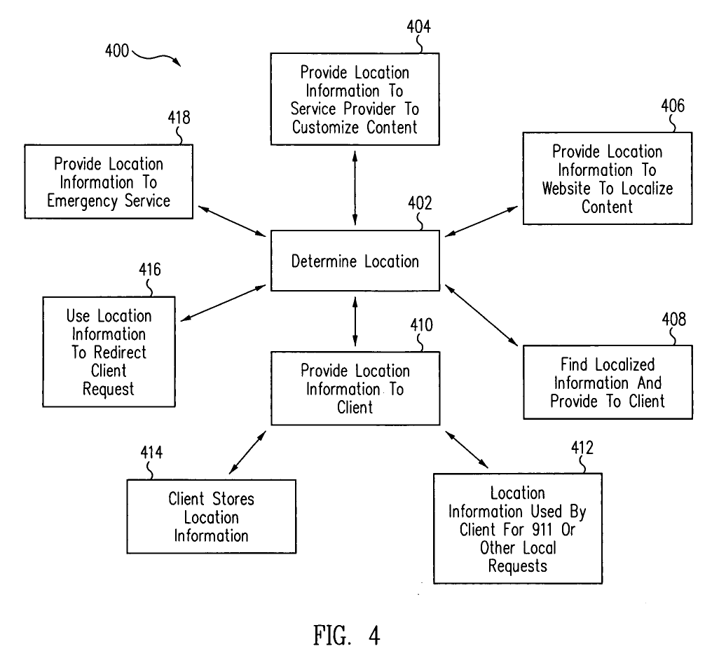

For example, FIG. 4 shows a diagram 400 illustrating location applications in accordance with an embodiment of the present invention. Specifically, diagram 400 illustrates various applications that may be provided to utilize the location information of access point 102 determined at a block 402. For example, the location information may be provided (e.g., by access point 102 and/or client 104) to service providers or content providers to customize the content provided to client 104 (block 404). The content may be provided to provide better service to client 104 (e.g., a customer or consumer using client 104), for example, with respect to localized searches, maps and directions (e.g., map of location and/or indication of location on map), directories (e.g., yellow or white pages), entertainment (e.g., movie times and locations or events), job searching, local advertising, and/or other localized content requested by client 104 or that the content provider would like to provide to client 104.

The location information may be provided (e.g., within a URL, a POST, a GET, or other conventional methods, including various HTML or HTTP commands) to a selected website so that the website may provide localized webpage content for client 104 (block 406). Access point 102 may also be programmed to utilize the location information to find relevant localized content and provide the content to clients 104 (block 408). For example, access point 102 may search and/or store localized content to provide to clients 104 on behalf of an entity (e.g., the hotspot operator, the location owner where access point 102 resides, and/or the service provider). Alternatively or in addition, access point 102 may utilize the location information to redirect requests (block 416) by clients 104 to localized content on network 106 (e.g., the Internet).

The location information may be provided to one or more clients 104 (block 410). For example, client 104 may utilize the location information provided by access point 102 to search for localized content on the Internet or client 104 (e.g., a user of client 104) may selectively provide the information to websites to provide localized content to client 104. As an example, client 104 may utilize the location information to provide the location when requesting emergency services (e.g., a 911 call) or for making other types of requests that would be useful to provide the location information (block 412). Alternatively or in addition, access point 102 may automatically provide the location information to emergency services (e.g., 911 call), such as for example if client 104 is making an emergency call and client 104 is a WiFi or dual-mode handset.

The location information may also be stored by client 104 to compile a list or map of known locations of access points 102 (e.g., map of known hot spot locations). This list or map may then be used as a reference to find a location of access point 102 for later use (block 414).

The location information may be provided to client 104 or via network 106 to a device (e.g., server 108) utilizing various conventional methods as would be understood by one skilled in the art. For example, the location information may be provided via XML, SOAP, SNMP, or other conventional communication protocols or included within an HTML POST, Get, or other type of HTTP commands.

Systems and methods are disclosed herein to provide location determination capability for an access point and applications based on the location information. For example, in accordance with an embodiment of the present invention, an access point is disclosed having GPS technology incorporated to determine the location of the access point. The location information may be utilized in various ways, such as to provide localized content, refine searches or information retrieval, or to direct emergency services. Various entities (e.g., service providers, access point vendors, hot spot operators or providers, and/or VoIP providers) may benefit from having location information determined by the access point.

Embodiments described above illustrate but do not limit the invention. It should also be understood that numerous modifications and variations are possible in accordance with the principles of the present invention. Accordingly, the scope of the invention is defined only by the following claims.

We claim:

1. An access point device for a network, the access point device comprising:
a processor adapted to control at least one function of the access point device;
a memory coupled to the processor;
a first interface for transferring information between the access point device and at least one client device;
a second interface for transferring information between the access point device and the network; and
a receiver for processing global positioning system signals used to determine an approximate location of the access point device.

2. The device of claim 1, wherein the access point device comprises at least one of a router and a gateway.

3. The device of claim 1, further comprising a modem for transferring information between the access point device and the network via the second interface.

4. The device of claim 1, further comprising an antenna, coupled to the access point device, adapted to receive the global positioning system signals for the receiver.

5. The device of claim 4, wherein the antenna is located a first distance from the access point device to receive the global positioning system signals.

6. The device of claim 1, wherein the first interface further comprises an antenna for transferring wirelessly the information between the access point device and the at least one client device.

7. The device of claim 1, wherein the access point device determines its approximate location.

8. The device of claim 1, wherein information from the global positioning system signals is provided to a server via the second interface, the server determining the approximate location of the access point device.

9. The device of claim 1, wherein the approximate location of the access point device is provided to at least one of the client devices.

10. The device of claim 9, wherein the approximate location is used by at least one of the client devices to compile locations of the access point devices.

11. The device of claim 1, wherein the approximate location of the access point device is used by at least one of the access point device, a service provider, and a content provider to provide localized information.

12. The device of claim 1, wherein the access point device provides the approximate location during an emergency services request by at least one of the client devices.

13. The device of claim 1, wherein the access point device uses the approximate location to perform at least one of redirect a request by at least one of the client devices and search via the network for localized information.

14. A network access point device comprising:
means for controlling a function of the network access point device;
means for providing communication between at least one client device and a network; and
means for receiving positioning signals to determine an approximate location of the network access point device.

15. A method of determining and using location information for a network access point device, the method comprising:
providing communication between at least one client device and a network via the network access point device;
receiving positioning signals by the network access point device; and
determining an approximate location of the network access point device based on the positioning signals.

16. The method of claim 15, wherein the providing communication further comprises:
providing communication between the at least one client device and the network access point device via a first interface; and
providing communication between the network and the network access point device via a second interface.

17. The method of claim 15, further comprising providing the approximate location of the network access point device to at least one of the client devices.

18. The method of claim 15, further comprising providing the approximate location of the network access point device to at least one of a service provider and a content provider to provide localized information to at least one of the client devices.

19. The method of claim 15, further comprising providing the approximate location during an emergency services request by at least one of the client devices

20. The method of claim 15, further comprising providing localized information to at least one of the client devices based on the approximate location of the network access point device.
